(19) United States
(12) Patent Application Publication
(10) Pub. No.: US 2025/0024229 A1
(43) Pub. Date: Jan. 16, 2025

(54) CONTROL SYSTEM AND METHOD FOR CONTROLLING THE POSITION OF A MOBILE TERMINAL BY MEANS OF A CONTROL SYSTEM

(71) Applicant: Robert Bosch GmbH, Stuttgart (DE)

(72) Inventors: Andreas Mueller, Waiblingen (DE); Johannes Von Hoyningen-Huene, Mielkendorf (DE); Rene Guillaume, Boeblingen (DE); Stephan Ludwig, Aalen-Waldhausen (DE)

(21) Appl. No.: 18/713,219

(22) PCT Filed: Nov. 28, 2022
(86) PCT No.: PCT/EP2022/083398

§ 371 Date: May 24, 2024

(30) Foreign Application Priority Data
Dec. 2, 2021 (DE) 10 2021 213 701.6

(51) Int. Cl. H04W 4/029; H04W 4/33; H04W 40/24

(52) U.S. Cl. CPC H04W 4/029; H04W 4/33; H04W 40/244

(57) ABSTRACT

A building infrastructure and a method for controlling the position of the terminal using a control system in a building.

### FIELD

The present invention relates to a control system and to a method for controlling the position of a mobile terminal by means of a control system.

### BACKGROUND INFORMATION

Location tracking via 5G is state of the art. For example, U.S. Patent No. U.S. Pat. No. 10,051,429 B2 describes checkpoint-based location monitoring via a mobile terminal.

PCT Patent Application No. WO 2017/015861 A1 shows a patrol monitoring system for security personnel and patrol monitoring methods for healthcare facilities.

Japan Patent No. JP 62-35267 B2 also describes a patrol work support system and a patrol work support method.

Systems that use a mobile radio terminal and 5G infrastructure and do not need to be held close to a contact point are not provided.

### SUMMARY

An advantage of the present invention is the combination of determining the location of a mobile terminal, without having to hold it close to a contact point.

The method works independently of the mobile radio standard, infrastructure hardware and mobile terminals actually used.

A method according to the invention for controlling the position of a mobile terminal is carried out by means of a control system and the use of mobile radio infrastructure in buildings. The main objective is to recognize whether a mobile terminal has reached a control point in the building. The control system maintains a connection with the mobile radio infrastructure.

According to an example embodiment of the present invention, the method comprises at least the following steps:
defining and storing the positions of the control points that must be accessed during a control tour in a documentation system of the control system,
notifying the control system that a tour of the security officer is to be recorded/documented by determining whether the mobile terminal reaches the control points,
registering the mobile terminal by means of a unique identification feature.

By determining which mobile radio antenna receives the signal from the mobile terminal, an integrated solution can be advantageously implemented for improved verification and documentation of the security acceptance.

Advantageously, according to an example embodiment of the present invention, the position of the mobile terminal is documented, wherein a movement track is continuously recorded. This has the advantage that a security officer can approach a control point in the building, without the security officer having to explicitly interact with the control point.

The position of the mobile terminal is advantageously used to determine the spatial distance from the mobile terminal to the control points, wherein the visit of a control point is entered into the system as soon as the determined distance from a control point becomes smaller than a specified reference value.

This has the following advantages:

The method allows the security officer to use his smartphone as a documentation trigger. This means that the control point does not have to be scanned manually with a reading device. This increases comfort, because both hands are free.

Furthermore, it saves material and organizational effort: no additional contact points need to be procured and installed. No reading device is necessary.

The solution is vendor-neutral, because standardized mobile phones are used rather than vendor-specific contact points. This allows for fair competition between security companies for the contract, without a change of provider that results in additional setup costs.

The client can use the mobile radio infrastructure, in particular in the case of private networks, to reliably check whether the control points have been properly accessed, without having to rely on information on the devices/scanners of the security service. This increases reliability.

The evaluation of whether all control points have been accessed can be carried out automatically. In case of deviation, the client can be informed.

The control points can be adjusted and configured using software with little effort, without having to reposition tags that would otherwise be necessary. This increases flexibility.

There is also no need for tags, which, due to their exposed installation, can be easily reached and may be damaged or tampered with.

The use of a mobile terminal allows localization to be integrated with other security and documentation functions.

To prevent centralized evaluation of the current position data of the security personnel, the present invention optionally provides for a time-delayed release/retrieval of the stored position data. For this purpose, an intermediate module can be used that does not pass on data records with a newer time stamp than the date defined by the delay to the further application.

Further advantageous developments of the present invention can be found in the figures and in the description herein of the figures.

### BRIEF DESCRIPTION OF THE DRAWINGS

FIG. 1 shows a building infrastructure with a building in a schematic representation, according to an example embodiment of the present invention.

FIG. 2 shows a method according to the invention for controlling the position of a mobile terminal, according to an example embodiment of the present invention.

FIG. 3 shows a further exemplary embodiment, according to an example embodiment of the present invention.

### DETAILED DESCRIPTION OF EXAMPLE EMBODIMENTS

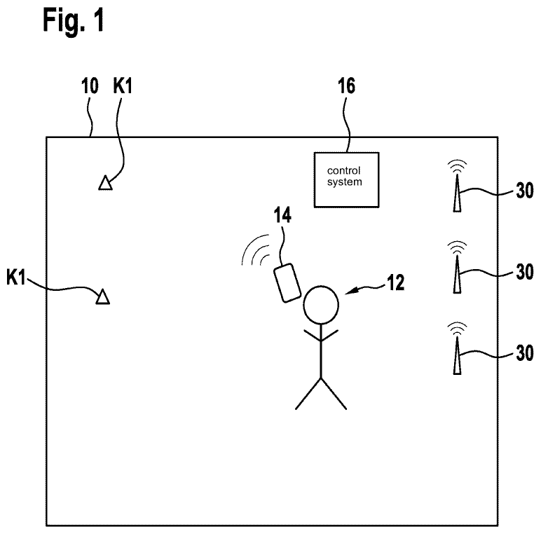

FIG. 1 shows an example of a building infrastructure with a building 10. The building 10 can be an office building, a museum, a factory or production hall, an administrative building, an educational institution or the like. There are a plurality of zones in the building, but at least a first control point K1 and a second control point K2.

A security officer 12 moves through building 10 and accesses the control points K1 and K2.

A control system 16 is used to control whether the control points K1, K2 are accessed. The control system 16 is a computer program stored on a computer, an app, or the like or a program stored in a cloud.

A security officer 12 carries a mobile terminal 14. In the exemplary embodiment, the mobile terminal 14 is a smartphone. However, the mobile terminal 14 can be of any design that appears reasonable to a person skilled in the art.

The control system 16 is provided to determine the position of the mobile terminal 14 and to record the reaching of defined waypoints.

In order to determine the position of the mobile terminal 14, a mobile radio infrastructure existing in the building 10 is used.

The mobile radio infrastructure comprises at least one base station. The mobile radio antennas 30 of the base station are located a short distance apart from each other.

The base station 30 of the 5th generation of mobile radio (5G) or subsequent standards is able to recognize the smallest distance between the mobile terminal 14 and one of the antennas 30.

Optionally, the system allows the position of the communication subscribers to be determined with an accuracy of up to 0.5 m, for example using multilateration or multiangulation methods. The position determination can be carried out in the mobile terminal or in the base station.

By using the information from the base station about the position of a terminal and linking successive position determinations, a direction of movement of the mobile terminal can be derived.

The reaching of defined waypoints is recorded.

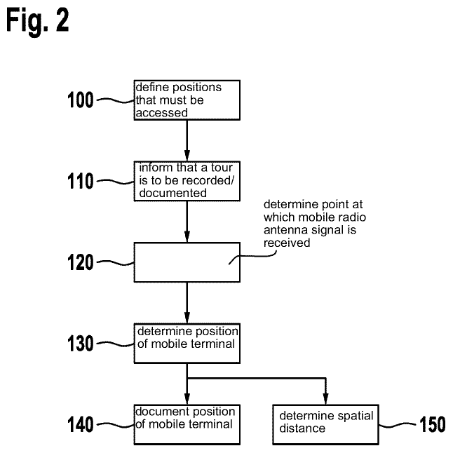

FIG. 2 shows how the existing infrastructure is used with the method described below:

In a first method step 100, the positions of the control points that must be accessed during a control tour are defined in a documentation system of the control system and stored in the control system.

In the documentation system, the positions of the control points K1, K2 that must be accessed during an inspection tour are defined and stored in the system.

At the beginning of the tour, the control system 16 is informed in a step 110 that a tour by the security officer 12 is to be recorded/documented using the control points K1, K2 of his mobile terminal 14. The mobile terminal 14 was registered in the system as a legitimate device in advance. For this purpose, the smartphone is registered in the system with a unique identification feature.

A unique identification feature is an identification number, an integrated circuit card identifier (ICCID), a universal integrated circuit card, a SIM card or the like. The identification feature connects to the audio system.

Identification can also be done by selecting from a list of already known identification features.

In addition, the recording can be released by authentication of the security personnel, e.g. based on a PIN, fingerprint or other suitable method.

In a step 120, the point at which mobile radio antenna 30 the signal of the mobile terminal 14 is received is continuously determined. The determination is made in the base station using the unique identification feature, which was reliably and securely determined by the base station using the security mechanisms of the mobile radio standard.

Optionally, in a step 130, the position of the mobile terminal 14 is determined by further localization mechanisms of mobile radio, e.g. multilateration or multiangulation using measured values from adjacent base station antennas.

In a step 140, the position of the mobile terminal 14 is documented, i.e., a movement track is continuously recorded. Using the position of the mobile terminal 14, the spatial distance from the mobile terminal 14 to the control points K1, K2 is determined in a step 150. If the specified distance from a control point K1, K2 is less than a specified reference value, the visit to the control point is entered in the system. Otherwise, nothing happens.

Steps 140 and 150 are performed either in combination or individually throughout the method.

Optionally, in addition to documentation, the visit to the control points can be automatically evaluated. The evaluation is carried out using an external system. An external system is a system that is outside the control system. The external system receives information about whether a control point was accessed within a certain time period or not. An external system can be the management office of the security company that employs the security officer. However, it can also be the client, an authority or the like.

Optionally, as a protective measure for the security officer, the movement of the safety officer can be continuously monitored and/or checked. If the security officer stops moving, an alarm can be triggered and further action, such as rescue measures, can be initiated. This makes it possible to advantageously recognize an accident or emergency in which something happens to security officer and take action.

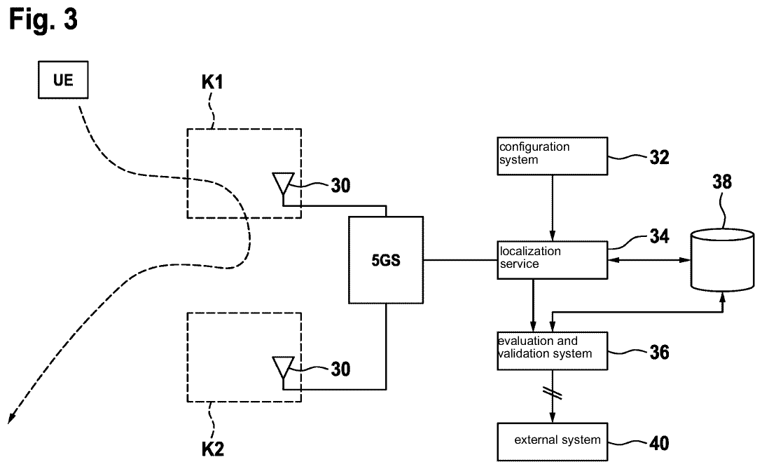

FIG. 3 shows a further exemplary embodiment of the invention.

FIG. 3 shows a first control point K1 and a second control point K2, a configuration system 32, a localization service 34, an evaluation and validation system 36 and a base station having mobile radio antennas 30.

A security officer 12 carries a mobile terminal 14. In the exemplary embodiment, the mobile terminal 14 is a smartphone. However, the mobile terminal 14 can be of any design that appears reasonable to a person skilled in the art.

The security officer 12 moves through the building 10 and passes the first control point K1. The 5G system (5GS) detects the position of the mobile terminal 14. The configuration system 32 defines the control points K1, K2 present in the building 10.

The passing of the first control point K1 is registered by comparing the position data generated by 5GS and the control points defined by the configuration system.

The localization system 34 stores the position data in the database 38

The stored data can be processed by the evaluation and validation system 36. For example, it can be reported whether or not a control point has been passed.

Optionally, in addition to documentation, the visit to the control points can be automatically evaluated. The evaluation is carried out using an external system 40. An external system is a system that is outside the control system. The external system 40 receives information about whether a control point was accessed within a certain time period or not. An external system can be the management office of the security company that employs the security officer. However, it can also be the client, an authority or the like.

Furthermore, a status or alarm message can be transmitted to the external system. This query can be subject to access control, which not only checks the legitimacy of the access, but also ensures time-limited access, for example to prevent real-time tracking of the security officer.

1-9. (canceled)

10. A building infrastructure, comprising:
a building;
at least a first control point and a second control point, wherein a security officer moves through the building and accesses the first and second control points; and
a control system configured to control whether the control points are accessed, wherein the control system is a computer program.

11. The building infrastructure according to claim 10, wherein the security officer carries a mobile terminal.

12. The building infrastructure according to claim 11, wherein the control system is configured to determine a position of the mobile terminal using a mobile radio infrastructure present in the building and to record reaching of defined waypoints.

13. The building infrastructure according to claim 12, wherein the mobile radio infrastructure comprises at least one base station and mobile radio antennas of the base station are arranged at a distance from one another that is less than or equal to 10 meters.

14. A building infrastructure, comprising:
a building;
a first control point;
a second control point;
a configuration system;
a localization service;
an evaluation and validation system; and
a base station having mobile radio antennas.

15. A method for controlling a position of the terminal using a control system and using mobile radio infrastructure, wherein the control system maintains a connection with the mobile radio infrastructure, the method comprising the following steps:
defining and storing positions of control points that must be accessed during a control tour in a documentation system of the control system;
notifying the control system that a tour of a security officer is to be recorded and/or documented by determining whether the mobile terminal reaches the control points; and
registering the mobile terminal using a unique identification feature.

16. The method according to claim 15, further comprising determining at which mobile radio antenna a signal of the mobile terminal is received, wherein the determination is carried out in the base station.

17. The method according to claim 16, wherein the position of the mobile terminal is documented, and wherein a movement track is continuously recorded.

18. The method according to claim 17, wherein a spatial distance from the mobile terminal to the control points is determined using the position of the mobile terminal, and wherein a visit of a control point of the control points is entered into the system as soon as the determined distance from the control point becomes smaller than a specified reference value.
